(19) United States
(12) Patent Application Publication
(10) Pub. No.: US 2026/0151967 A1
(43) Pub. Date: Jun. 4, 2026

(54) EXTRUSION COMPENSATION METHOD FOR EXTRUSION WHEEL, 3D PRINTER AND ELECTRONIC DEVICE

(71) Applicant: SHENZHEN TUOZHU TECHNOLOGY CO., LTD., Shenzhen (CN)

(72) Inventor: Zihan CHEN, Shenzhen (CN)

(73) Assignee: SHENZHEN TUOZHU TECHNOLOGY CO., LTD., Shenzhen (CN)

(21) Appl. No.: 19/460,275

(22) Filed: Jan. 26, 2026

Related U.S. Application Data
(63) Continuation of application No. PCT/CN2024/107737, filed on Jul. 26, 2024.

(30) Foreign Application Priority Data
Aug. 28, 2023 (CN) 202311099096.7

(51) Int. Cl. B29C 64/393; B29C 64/321; B33Y 50/02

(52) U.S. Cl. CPC B29C 64/393; B29C 64/321; B33Y 50/02

(57) ABSTRACT

The disclosure provides an extrusion compensation method for an extrusion wheel, a 3D printer and an electronic device, and the extrusion compensation method includes the following steps: controlling an extrusion wheel of a 3D printer to switch from a first extrusion speed to a second extrusion speed in a case of compensation by a first compensation coefficient to extrude a printing material to a hot end assembly of the 3D printer; obtaining data indicative of an extrusion force or a deformation applied to the hot end assembly, the data corresponding to the first compensation coefficient from a measurement assembly of the 3D printer; obtaining a target compensation coefficient of the extrusion wheel based on the data indicative of the extrusion force or the deformation applied to the hot end assembly, the data corresponding to the first compensation coefficient; and controlling the extrusion wheel to extrude the printing material to the hot end assembly based on the target compensation coefficient of the extrusion wheel.

### CROSS-REFERENCES TO RELATED APPLICATIONS

The present application is a continuation of International Patent Application No. PCT/CN2024/107737, filed on Jul. 26, 2024, which claims priority to Chinese Patent Application No. 202311099096.7, filed with the China National Intellectual Property Administration on Aug. 28, 2023 and entitled “EXTRUSION COMPENSATION METHOD FOR EXTRUSION WHEEL, 3D PRINTER, AND ELECTRONIC DEVICE”, the content of which is incorporated herein by reference in its entirety.

### FIELD

The present application relates to the technical field of 3D printing, and in particular, to an extrusion compensation method for an extrusion wheel, a 3D printer, and an electronic device.

### BACKGROUND

During the process of fused deposition modeling (FDM) 3D printing, the extrusion wheel in the 3D printer extrudes the printing material to the hot end assembly, and the printing material is heated by the hot end assembly to a molten state and then flows out.

Due to the compliant nature of the extrusion feeding process of the extrusion wheel, when the extrusion speed of the extrusion wheel varies, the hot end assembly is unable to achieve a desired flow rate change. In one embodiment, when the extrusion speed of the extrusion wheel decreases, the flow rate of the hot end assembly is excessively high, resulting in a large number of printing materials being stocked in the low-speed area where the printing head moves and causing bulging; when the extrusion speed of the extrusion wheel increases, the flow rate of the hot end assembly is excessively low, resulting in material shortage in the high-speed area where the printing head moves and causing gaps.

In view of the above problems, the extrusion feed amount of one extrusion wheel may be increased or decreased based on a desired flow rate, that is, by configuring a compensation coefficient for the extrusion wheel, to rapidly change the pressure of the melt chamber in the hot end assembly, thereby rapidly changing the flow rate of the hot end assembly. Therefore, how to determine the compensation coefficient of the extrusion wheel is a key issue that needs to be studied.

### SUMMARY

The present application provides an extrusion compensation method for an extrusion wheel, a 3D printer, and an electronic device.

An embodiment of the present application provides an extrusion compensation method for an extrusion wheel. The extrusion compensation method includes:
controlling an extrusion wheel of a 3D printer, in a case of compensation by a first compensation coefficient, to switch from a first extrusion speed to a second extrusion speed to extrude a printing material to a hot end assembly of the 3D printer;
obtaining, from a measurement assembly of the 3D printer, data indicative of an extrusion force or a deformation applied to the hot end assembly, the data corresponding to the first compensation coefficient;
obtaining a target compensation coefficient of the extrusion wheel based on the data indicative of the extrusion force or the deformation applied to the hot end assembly, the data corresponding to the first compensation coefficient; and
controlling the extrusion wheel to extrude the printing material to the hot end assembly based on the target compensation coefficient of the extrusion wheel.

An embodiment of the present application provides a 3D printer. The 3D printer includes:
a printing head including a printing head body, where the printing head body is provided with an extrusion wheel and a hot end assembly;
a measurement assembly configured to measure an extrusion force or a deformation applied to the hot end assembly; and
a controller including:
at least one processor; and
at least one memory including a computer program code, where the at least one memory, the computer program code, and the at least one processor are collectively configured, to cause the 3D printer to at least perform:
controlling the extrusion wheel, in a case of compensation by a first compensation coefficient, to switch from a first extrusion speed to a second extrusion speed to extrude a printing material to the hot end assembly;
obtaining, from the measurement assembly of the 3D printer, data indicative of an extrusion force or a deformation applied to the hot end assembly, the data corresponding to the first compensation coefficient;
obtaining a target compensation coefficient of the extrusion wheel based on the data indicative of the extrusion force or the deformation applied to the hot end assembly, the data corresponding to the first compensation coefficient; and
controlling the extrusion wheel to extrude the printing material to the hot end assembly based on the target compensation coefficient of the extrusion wheel.

An embodiment of the present application provides an electronic device. The electronic device includes:
at least one processor; and
at least one memory including a computer program code, where the at least one memory, the computer program code, and the at least one processor are collectively configured, to cause the electronic device to at least perform:
controlling an extrusion wheel of a 3D printer, in a case of compensation by a first compensation coefficient, to switch from a first extrusion speed to a second extrusion speed to extrude a printing material to a hot end assembly of the 3D printer;
obtaining, from a measurement assembly of the 3D printer, data indicative of an extrusion force or a deformation applied to the hot end assembly, the data corresponding to the first compensation coefficient;
obtaining a target compensation coefficient of the extrusion wheel based on the data indicative of the extrusion force or the deformation applied to the hot end assembly, the data corresponding to the first compensation coefficient; and
controlling the extrusion wheel to extrude the printing material to the hot end assembly based on the target compensation coefficient of the extrusion wheel.

It should be understood that for implementation and beneficial effects of the above aspects of the present application, reference may be made to each other.

### BRIEF DESCRIPTION OF THE DRAWINGS

FIG. 1 is a schematic diagram of an object printed by a related 3D printer when the printing speed changes;

FIG. 2 is a schematic structural diagram of a 3D printer according to an embodiment of the present application;

FIG. 3 is a schematic flowchart of an extrusion compensation method for an extrusion wheel according to an embodiment of the present application;

FIG. 4 is a schematic structural diagram of a printing head according to an embodiment of the present application;

FIG. 5 is another schematic structural diagram of a printing head according to an embodiment of the present application;

FIG. 6 is a schematic diagram of the curve of an extrusion force applied to a hot end assembly according to an embodiment of the present application;

FIG. 7 is a schematic diagram of the curve of the flow rate of a hot end assembly according to an embodiment of the present application;

FIG. 8 is a schematic diagram of a flow rate area difference of an extrusion force according to an embodiment of the present application; and

FIG. 9 is another schematic flowchart of an extrusion compensation method for an extrusion wheel according to an embodiment of the present application.

### DETAILED DESCRIPTION

Embodiments of the present application will be further described in detail below with reference to the accompanying drawings.

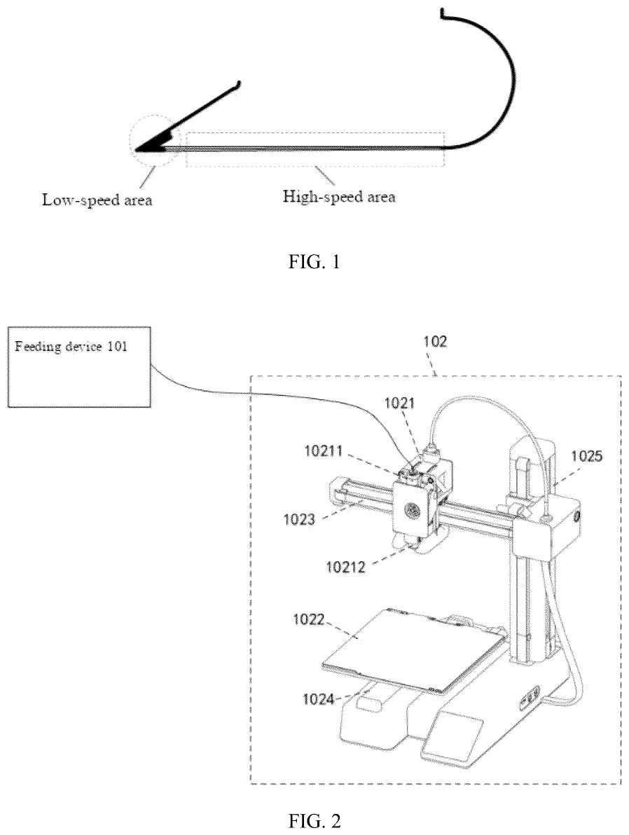

Due to the compliant nature of the extrusion feeding process of the extrusion wheel, when the extrusion speed of the extrusion wheel varies, the hot end assembly is unable to achieve a desired flow rate change. For example, as shown in FIG. 1, when the extrusion speed of the extrusion wheel decreases, the flow rate of the hot end assembly is excessively high, resulting in a large number of printing materials being stocked in the low-speed area where the printing head moves and causing bulging; when the extrusion speed of the extrusion wheel increases, the flow rate of the hot end assembly is excessively low, resulting in material shortage in the high-speed area where the printing head moves and causing gaps.

An embodiment of the present application provides an extrusion compensation method for an extrusion wheel, a 3D printer, and an electronic device, which can automatically compensate for the extrusion feed amount of the extrusion wheel, avoids the need for user intervention, and enables high automation and high speed.

In the embodiment of the present application, a compensation coefficient of the extrusion wheel can be automatically calibrated, thereby achieving automatic compensation for the extrusion feed amount of the extrusion wheel, avoiding the need for user intervention, and enabling high automation, high speed, high efficiency, and low cost.

With reference to the first aspect, in a first possible implementation, obtaining information of the extrusion force or the deformation applied to the hot end assembly includes:
obtaining information of one or more extrusion forces or deformations applied to the hot end assembly after a moment at which the extrusion wheel switches the extrusion speed. In an embodiment, the information of the extrusion force or the deformation includes data indicative of an extrusion force or a deformation. In an embodiment, data indicative of an extrusion force or a deformation includes the extrusion force or deformation itself, or relevant data that can be used to characterize or calculate the extrusion force or deformation, such as frequency. It is worth noting that, in each embodiment of the present application, examples described with reference to an extrusion force are equally applicable to a deformation.

With reference to the first aspect or any one of the above possible implementations of the first aspect, in a second possible implementation, obtaining the target compensation coefficient of the extrusion wheel based on the information of the one or more extrusion forces or deformations applied to the hot end assembly corresponding to the first compensation coefficient includes:
controlling the extrusion wheel, in a case of compensation by a second compensation coefficient, to switch from a third extrusion speed to a fourth extrusion speed to extrude the printing material to the hot end assembly, where the third extrusion speed may be the first extrusion speed, and the fourth extrusion speed may be the second extrusion speed;
obtaining information of one or more extrusion forces or deformations applied to the hot end assembly corresponding to the second compensation coefficient; and
obtaining the target compensation coefficient of the extrusion wheel based on the information of the one or more extrusion forces or deformations applied to the hot end assembly corresponding to the first compensation coefficient and the information of the one or more extrusion forces or deformations applied to the hot end assembly corresponding to the second compensation coefficient.

In the present application, the compensation coefficient is iterated, and the target compensation coefficient of the extrusion wheel is determined based on one or more extrusion forces applied to the hot end assembly corresponding to different compensation coefficients. The accuracy of the target compensation coefficient is improved.

With reference to the first aspect or any one of the above possible implementations of the first aspect, in a third possible implementation, the one or more extrusion forces applied to the hot end assembly include a theoretical extrusion force and an actual extrusion force.

Obtaining the target compensation coefficient of the extrusion wheel based on the information of the one or more extrusion forces or deformations applied to the hot end assembly corresponding to the first compensation coefficient and the information of the one or more extrusion forces or deformations applied to the hot end assembly corresponding to the second compensation coefficient includes:
integrating a difference between the theoretical extrusion force and the actual extrusion force of the hot end assembly corresponding to a same compensation coefficient with respect to time over an extrusion speed variation cycle of the extrusion wheel to obtain a flow rate difference of the hot end assembly corresponding to the first compensation coefficient and a flow rate difference of the hot end assembly corresponding to the second compensation coefficient, respectively; and
obtaining the target compensation coefficient of the extrusion wheel based on a sign relationship between the flow rate difference of the hot end assembly corresponding to the first compensation coefficient and the flow rate difference of the hot end assembly corresponding to the second compensation coefficient.

In the present application, in consideration of different materials, different heating temperatures of the printing material by the hot end assembly, and different orifice radii for flowing out the molten printing material in the hot end assembly, when the extrusion speed of the extrusion wheel varies, there is a difference between the actual extrusion force exerted by the printing material on the hot end assembly and the theoretical extrusion force. Therefore, the target compensation coefficient of the extrusion wheel can be calibrated based on the difference between the actual extrusion force exerted by the printing material on the hot end assembly and the theoretical extrusion force. The accuracy is high.

With reference to the first aspect or any one of the above possible implementations of the first aspect, in a fourth possible implementation, obtaining the target compensation coefficient of the extrusion wheel based on the sign relationship between the flow rate difference of the hot end assembly corresponding to the first compensation coefficient and the flow rate difference of the hot end assembly corresponding to the second compensation coefficient includes:
when the flow rate difference of the hot end assembly corresponding to the first compensation coefficient is a positive value, and the flow rate difference of the hot end assembly corresponding to the second compensation coefficient is a negative value, using the second compensation coefficient as the target compensation coefficient of the extrusion wheel. In this case, the first compensation coefficient is relatively small, and the second compensation coefficient is relatively large; that is, the second compensation coefficient is close to the desired value and can be used as the target compensation coefficient of the extrusion wheel to improve the printing effect of the 3D printer.

With reference to the first aspect or any one of the above possible implementations of the first aspect, in a fifth possible implementation, obtaining the target compensation coefficient of the extrusion wheel based on the sign relationship between the flow rate difference of the hot end assembly corresponding to the first compensation coefficient and the flow rate difference of the hot end assembly corresponding to the second compensation coefficient includes:
when the flow rate difference of the hot end assembly corresponding to the first compensation coefficient is a negative value, and the flow rate difference of the hot end assembly corresponding to the second compensation coefficient is a positive value, using the second compensation coefficient as the target compensation coefficient of the extrusion wheel. In this case, the first compensation coefficient is relatively large, and the second compensation coefficient is relatively small; that is, the second compensation coefficient is close to the desired value and can be used as the target compensation coefficient of the extrusion wheel to improve the printing effect of the 3D printer.

With reference to the first aspect or any one of the above possible implementations of the first aspect, in a sixth possible implementation, obtaining the target compensation coefficient of the extrusion wheel based on the sign relationship between the flow rate difference of the hot end assembly corresponding to the first compensation coefficient and the flow rate difference of the hot end assembly corresponding to the second compensation coefficient includes:
when both the flow rate difference of the hot end assembly corresponding to the first compensation coefficient and the flow rate difference of the hot end assembly corresponding to the second compensation coefficient are positive values, increasing the second compensation coefficient by a first preset step size until a flow rate difference of the hot end assembly corresponding to the increased second compensation coefficient is a negative value, and using the increased second compensation coefficient as the target compensation coefficient of the extrusion wheel.

In the present application, the flow rate of the hot end assembly is changed by dynamically changing the compensation coefficient. The operation is simple and the efficiency is high.

With reference to the first aspect or any one of the above possible implementations of the first aspect, in a seventh possible implementation, obtaining the target compensation coefficient of the extrusion wheel based on the sign relationship between the flow rate difference of the hot end assembly corresponding to the first compensation coefficient and the flow rate difference of the hot end assembly corresponding to the second compensation coefficient includes:
when both the flow rate difference of the hot end assembly corresponding to the first compensation coefficient and the flow rate difference of the hot end assembly corresponding to the second compensation coefficient are negative values, decreasing the second compensation coefficient by a second preset step size until a flow rate difference of the hot end assembly corresponding to the decreased second compensation coefficient is a positive value, and using the decreased second compensation coefficient as the target compensation coefficient of the extrusion wheel.

In the present application, the flow rate of the hot end assembly is changed by dynamically changing the compensation coefficient. The operation is simple and the efficiency is high.

With reference to the first aspect or any one of the above possible implementations of the first aspect, in an eighth possible implementation, the extrusion speed variation cycle of the extrusion wheel includes a first period and a second period; a theoretical extrusion force corresponding to each compensation coefficient includes a first theoretical extrusion force and a second theoretical extrusion force; an actual extrusion force corresponding to each compensation coefficient includes a first actual extrusion force and a second actual extrusion force.

Integrating the difference between the theoretical extrusion force and the actual extrusion force of the hot end assembly corresponding to the same compensation coefficient with respect to time over the extrusion speed variation cycle of the extrusion wheel to obtain the flow rate difference of the hot end assembly corresponding to the first compensation coefficient and the flow rate difference of the hot end assembly corresponding to the second compensation coefficient, respectively, includes:
integrating a difference obtained by subtracting the first actual extrusion force from the first theoretical extrusion force corresponding to each compensation coefficient with respect to time over the first period to obtain a first flow rate area difference corresponding to each compensation coefficient;
integrating a difference obtained by subtracting the second theoretical extrusion force from the second actual extrusion force corresponding to each compensation coefficient with respect to time over the second period to obtain a second flow rate area difference corresponding to each compensation coefficient; and
using a sum of the first flow rate area difference corresponding to each compensation coefficient and the second flow rate area difference as the flow rate difference corresponding to each compensation coefficient.

In the present application, the flow rate area difference of each compensation coefficient is obtained during the acceleration of the extrusion wheel, and the flow rate area difference of each compensation coefficient is obtained during the deceleration of the extrusion wheel. The acceleration and deceleration processes of the extrusion wheel are comprehensively considered, and the accuracy is further improved. In addition, the target compensation coefficient obtained according to the present application is applicable to different application scenarios of the extrusion wheel, especially during the process of the 3D printer printing a sharp corner, in which the extrusion wheel decelerates in the horizontal direction and accelerates in the vertical direction, and the overall speed of the extrusion wheel exhibits a variation process of acceleration, deceleration, and then acceleration. During this process, the extrusion feed amount of the extrusion wheel can be compensated by a target compensation coefficient, avoiding the need for frequently changing the value of the compensation coefficient, and the reliability is high.

With reference to the first aspect or any one of the above possible implementations of the first aspect, in a ninth possible implementation, during the first period, the extrusion force corresponding to the first compensation coefficient increases from a first moment and tends to be stable at a second moment;
the first actual extrusion force corresponding to the first compensation coefficient is an extrusion force corresponding to the first compensation coefficient between the first moment and the second moment;
the first theoretical extrusion force corresponding to the first compensation coefficient is an extrusion force after the second moment during the first period.

In the present application, the extrusion wheel continuously increases the extrusion printing material during the acceleration period, and the extrusion force applied to the hot end assembly continuously increases and then tends to be stable. The value at which the extrusion force tends to be stable is the theoretical extrusion force of the extrusion wheel. In this case, the value obtained through sampling is used as the theoretical value, which avoids tedious theoretical calculation, saves calculation resources for the system, and provides high efficiency.

With reference to the first aspect or any one of the above possible implementations of the first aspect, in a tenth possible implementation, during the second period, the extrusion force corresponding to the first compensation coefficient decreases from a third moment and tends to be stable at a fourth moment;
the second actual extrusion force corresponding to the first compensation coefficient is an extrusion force corresponding to the first compensation coefficient between the third moment and the fourth moment;
the second theoretical extrusion force corresponding to the first compensation coefficient is an extrusion force after the fourth moment during the second period.

In the present application, the extrusion wheel continuously decreases the extrusion printing material during the deceleration period, and the extrusion force applied to the hot end assembly continuously decreases and then tends to be stable. The value at which the extrusion force tends to be stable is the theoretical extrusion force of the extrusion wheel. In this case, the value obtained through sampling is used as the theoretical value, which avoids tedious theoretical calculation, saves calculation resources for the system, and provides high efficiency.

With reference to the first aspect or any one of the above possible implementations of the first aspect, in an eleventh possible implementation, the extrusion wheel is connected to a motor.

Extruding the printing material to the hot end assembly at different extrusion speeds includes:
controlling the motor to rotate at different rotational speeds, and the extrusion wheel extrudes the printing material to the hot end assembly at different extrusion speeds.

In the present application, the extrusion speed of the extrusion wheel can be controlled only by controlling the rotational speed of the motor, enabling high automation.

With reference to the first aspect or any one of the above possible implementations of the first aspect, in a twelfth possible implementation, the 3D printer is provided with a support between the extrusion wheel and the hot end assembly, where a distance sensing device is arranged on a side of the support facing the hot end assembly.

The distance sensing device is configured to sense and measure a distance between the hot end assembly and the support, to obtain the extrusion force applied to the hot end assembly corresponding to the first compensation coefficient.

In the present application, the cost of measuring the extrusion force applied to the hot end assembly can be reduced, the structure is simple, and the space is compact.

Referring to FIG. 2, FIG. 2 is a schematic structural diagram of a 3D printer according to an embodiment of the present application. As shown in FIG. 2, the 3D printer 102 is connected to a feeding device 101.

The feeding device 101 can hang a filament spool, and a printing material is wound around the filament spool. The feeding device 101 can provide the printing material to the 3D printer 102.

The 3D printer 102 includes a printing head 1021. The printing head 1021 includes a filament guide unit 10211, a hot end assembly 10212, and an extrusion wheel arranged between the filament guiding unit 10211 and the hot end assembly 10212. During the feeding process of the feeding device 101, the printing material passes through the filament guide unit 10211 and enters the extrusion wheel, and the extrusion wheel provides the printing material to the hot end assembly 10212.

In one embodiment, the 3D printer 102 further includes a print table 1022, and the hot end assembly 10212 can extrude a printing material in a molten state onto the print table 1022.

In a specific implementation, the printing head 1021 is slidably connected to a first guide rail 1023, and the printing head 1021 can move along the length direction of the first guide rail 1023, that is, realizing the displacement of the printing head 1021 relative to the print table 1022 along the length direction of the first guide rail 1023. The print table 1022 is slidably connected to a second guide rail 1024, and the print table 1022 moves along the length direction of the second guide rail 1024, that is, realizing the displacement of the printing head 1021 relative to the print table 1022 along the length direction of the second guide rail 1024. The length direction of the second guide rail 1024 is perpendicular to the length direction of the first guide rail 1023. Moreover, the first guide rail 1023 is connected to a third guide rail 1025. The 3D printer 102, by moving the first guide rail 1023 along the third guide rail 1025, can realize the displacement of the printing head 1021 relative to the print table 1022 in the direction perpendicular to the length of the second guide rail 1024 and in the direction perpendicular to the length of the first guide rail 1023. That is, the 3D printer 102 can implement three printing paths in directions perpendicular to each other, thereby printing three-dimensional objects.

In the present application, by automatically calibrating the compensation coefficient of the extrusion wheel, the extrusion feed amount of the extrusion wheel is automatically compensated, that is, compensating for the printing material provided by the extrusion wheel for the hot end assembly. This avoids the need for user intervention, and enables high automation, high speed, high efficiency, and low cost.

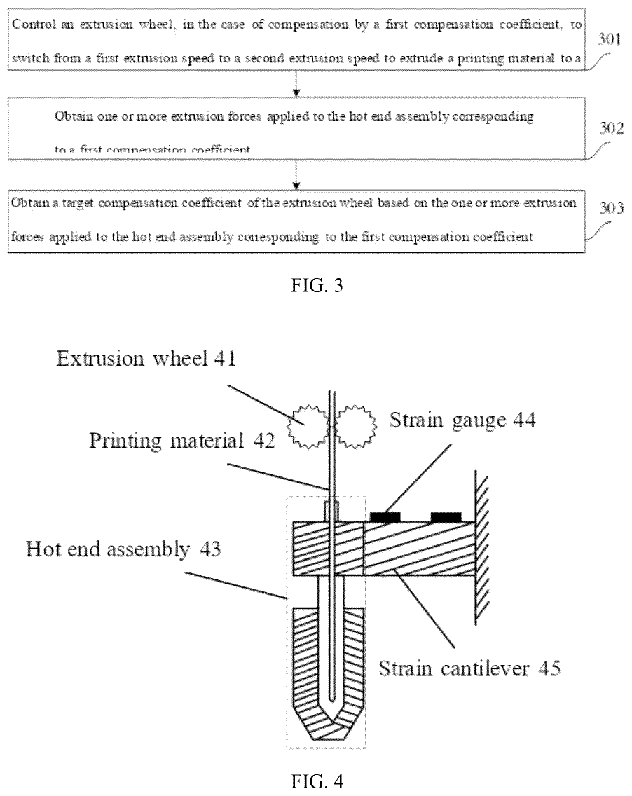

The extrusion compensation method for an extrusion wheel according to the present application will be described in detail below with reference to FIGS. 3 to 9.

Referring to FIG. 3, FIG. 3 is a schematic flowchart of an extrusion compensation method for an extrusion wheel according to an embodiment of the present application, which is designated as process 300 in the figure. Some or all aspects of the process 300 (or any other processes herein, or variations and/or combinations thereof) may be performed by one or more processors onboard the 3D printer, and/or a remote terminal. Some or all aspects of the process 300 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program including a plurality of instructions executable by one or more processors. The computer-readable storage medium may be non-transitory. The order in which the operations are described is not intended to be construed as a limitation, and any number of the described operations may be combined in any order and/or in parallel to implement of the processes. As shown in FIG. 3, the extrusion compensation method for an extrusion wheel includes the following steps.

In step 301, an extrusion wheel is controlled, in the case of compensation by a first compensation coefficient, to switch from a first extrusion speed to a second extrusion speed to extrude a printing material to a hot end assembly.

The steps of the extrusion compensation method according to the present application may be performed by one controller or one or more controllers having a communication connection. The controller may be arranged on a printing head of the 3D printer, a base connected to the second guide rail, or a base connected to the third guide rail. That is, the number of controllers and the locations at which the controllers are arranged are not limited in the present application.

In one embodiment, the controller may be a micro control unit (MCU), a central processing unit (CPU), another general-purpose processor, a digital signal processor (DSP), an application specific integrated circuit (ASIC), a field-programmable gate array (FPGA), or another programmable logic device, a discrete gate or a transistor logic device, a discrete hardware component, or the like.

The extrusion wheel is connected to a motor, and the motor can rotate at different rotational speeds based on different control signals sent by the controller, and the extrusion wheel can extrude the printing material to the hot end assembly at different extrusion speeds. In one embodiment, the extrusion wheel is connected to a motor shaft of the motor; that is, the rotational speed of the motor is associated with the extrusion speed of the extrusion wheel, and the extrusion speed of the extrusion wheel can be switched only by controlling the rotational speed of the motor.

In step 302, one or more extrusion forces applied to the hot end assembly corresponding to the first compensation coefficient are obtained. In one embodiment, data indicative of an extrusion force or a deformation applied to the hot end assembly, the data corresponding to the first compensation coefficient from a measurement assembly of the 3D printer is obtained. In one embodiment, information of the extrusion force or the deformation applied to the hot end assembly corresponding to the first compensation coefficient can be obtained from a measurement assembly, and the information of the extrusion force or the deformation of the hot end assembly corresponding to the first compensation coefficient includes a theoretical extrusion force or deformation and an actual extrusion force or deformation that correspond to the first compensation coefficient. In one embodiment, the theoretical extrusion force or deformation may be a preset target value, and the actual extrusion force or deformation may be measured by the measurement assembly. In one embodiment, the measurement assembly includes a strain gauge or a distance sensing device.

When the extrusion speed of the extrusion wheel varies, the pressure of the melt chamber in the hot end assembly varies, and the extrusion force applied to the hot end assembly also varies. In a specific implementation, a start moment at which the one or more extrusion forces applied to the hot end assembly corresponding to the first compensation coefficient are obtained is a moment at which the extrusion speed of the extrusion wheel is switched.

In some feasible embodiments, in the present application, a cantilever-surface strain method may be employed to measure the extrusion force applied to the hot end assembly. Referring to FIG. 4, FIG. 4 is a schematic structural diagram of a printing head according to an embodiment of the present application. As shown in FIG. 4, the hot end assembly 43 is connected to one end of a strain cantilever 45, and the other end of the strain cantilever 45 is fixed. The surface of the strain cantilever 45 is attached with a strain gauge 44. When the extrusion wheels 41 extrude the printing material 42 to the hot end assembly 43, the extrusion force exerted by the printing material 42 on the hot end assembly 43 is transmitted to the strain cantilever 45, and the surface of the strain cantilever 45 is subjected to strain. In this case, the deformation of the surface of the strain cantilever 45 can be measured through the strain gauge 44. The deformation amount of the strain gauge 44 is associated with the extrusion force applied to the hot end assembly 43. Thus, the extrusion force applied to the hot end assembly 43 can be further measured based on the deformation amount of the strain gauge 44.

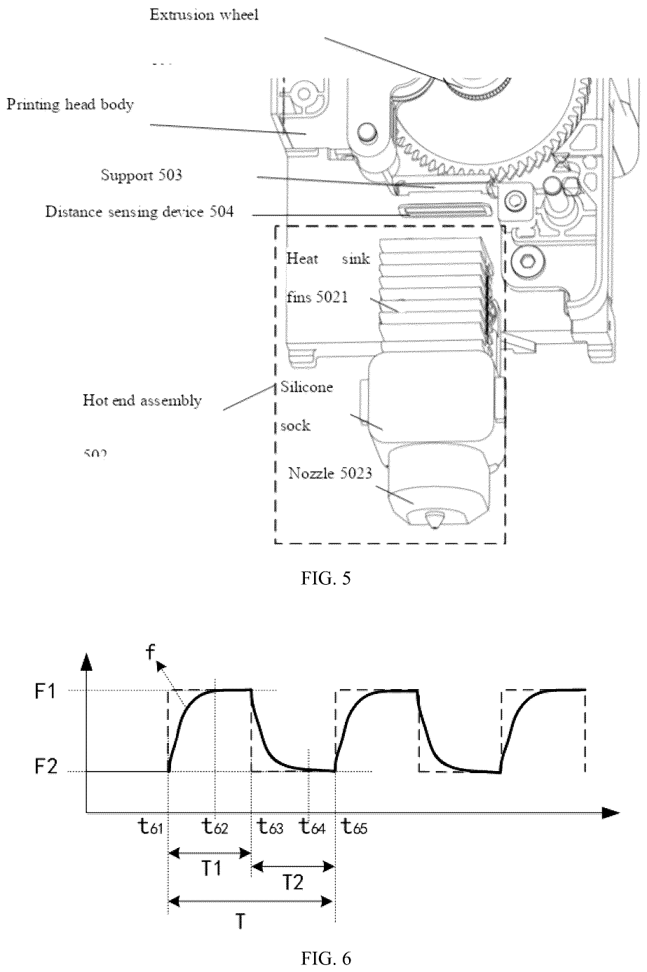

In one embodiment, in some feasible embodiments, referring to FIG. 5, FIG. 5 is another schematic structural diagram of a printing head according to an embodiment of the present application. As shown in FIG. 5, a printing head body 500 is provided with an extrusion wheel 501, a hot end assembly 502, and a support 503 located between the extrusion wheel 501 and the hot end assembly 502.

A distance sensing device 504 is arranged on a side of the support 503 facing the hot end assembly 502, and the distance sensing device 504 can sense and measure the distance between the hot end assembly 502 and the support 503, to obtain the extrusion force exerted by the printing material on the hot end assembly 502.

In one embodiment, the hot end assembly 502 includes heat sink fins 5021, a nozzle 5023, and a heating unit. The heating unit can be configured to heat the printing material, and the printing material, after being in a molten state, is extruded from the nozzle 5023.

The rigidity of the printing head body 500 is within a certain range—the rigidity refers to the ability of a material or a structure to resist elastic deformation when subjected to a force—that is, the printing head body 500 is not completely rigid. When the extrusion wheel 501 extrudes the printing material to the hot end assembly 502, the nozzle 5023 in the hot end assembly 502 is subjected to an extrusion force to drive the heat sink fins 5021 to move toward a side away from the extrusion wheel 501, and the distance between the hot end assembly 502 and the support 503 changes. Thus, the distance between the hot end assembly 502 and the support 503 has an association relationship with the extrusion force exerted by the printing material on the hot end assembly 502. After the distance between the hot end assembly 502 and the support 503 is obtained, the extrusion force exerted by the printing material on the hot end assembly 502 can be obtained by conversion between the distance and the extrusion force.

In one embodiment, the hot end assembly 502 may further include a silicone sock 5022. The silicone sock 5022 is arranged around the heating unit to prevent heat loss of the heating unit and prevent a user from being scalded when touching the hot end assembly accidentally.

In the embodiments of the present application, the distance sensing device is added between the support and the hot end assembly. Through the distance sensing device, the distance between the hot end assembly and the support is sensed and measured, thereby obtaining the extrusion force exerted by the printing material on the hot end assembly (i.e., the extrusion force applied to the hot end assembly). This makes the structure simple and provides high design flexibility, high space utilization rate, and low cost.

In some feasible embodiments, the distance sensing device 504 includes a coil, and the plane on which the coil is located is parallel to the surface of the heat sink fin 5021.

In one embodiment, taking one or more compensation coefficients including the first compensation coefficient as an example, in the case of compensation by the first compensation coefficient, switching the extrusion speed of the extrusion wheel and obtaining one or more extrusion forces applied to the hot end assembly through measurement may be as shown in FIG. 6. During the extrusion speed variation cycle T of the extrusion wheel, the extrusion force f applied to the hot end assembly varies. Taking the extrusion force f being represented as the solid line in FIG. 6 as an example,

the extrusion speed of the extrusion wheel increases during the first period T1 (i.e., from the first moment t₆₁t₆₁ to the third moment t₆₃). During the first period T1, the extrusion force f applied to the hot end assembly increases from the first moment t₆₁ and tends to be stable at the second moment t₆₂. In this case, the extrusion force f applied to the hot end assembly between the first moment t₆₁ and the second moment t₆₂ can be used as the first actual extrusion force applied to the hot end assembly corresponding to the first compensation coefficient, and the extrusion force f applied to the hot end assembly after the second moment t₆₂ during the first period T1, i.e. between the second moment t₆₂ and the third moment t₆₂, can be used as the first theoretical extrusion force F1 applied to the hot end assembly corresponding to the first compensation coefficient. In one embodiment, that the extrusion force f applied to the hot end assembly tends to be stable at the second moment t₆₂ can be understood as that the value of the extrusion force sampled at the second moment t₆₂ and the value of the extrusion force sampled at the previous sampling moment relative to the second moment t₆₂ are within a preset range. For example, the value of the extrusion force sampled at the second moment t₆₂ is equal to the value of the extrusion force sampled at the previous sampling moment relative to the second moment t₆₂.

In the present application, the extrusion wheel continuously increases the extrusion printing material during the acceleration period, and the extrusion force applied to the hot end assembly continuously increases and then tends to be stable. The value at which the extrusion force tends to be stable is the theoretical extrusion force of the extrusion wheel. In this case, the value obtained through sampling is used as the theoretical value, which avoids tedious theoretical calculation, saves calculation resources for the system, and provides high efficiency.

Similarly, the extrusion speed of the extrusion wheel decreases during the second period T2 (i.e., from the third moment t₆₂ to the fifth moment t₆₂). During the second period T2, the extrusion force f applied to the hot end assembly decreases from the third moment t₆₃ and tends to be stable at the fourth moment t₆₄. In this case, the extrusion force f applied to the hot end assembly between the third moment t₆₃ and the fourth moment t₆₄ can be used as the second actual extrusion force applied to the hot end assembly corresponding to the first compensation coefficient, and the extrusion force f applied to the hot end assembly after the fourth moment t₆₄ during the second period T2, i.e., between the fourth moment t₆₄ and the fifth moment t₆₄ can be used as the second theoretical extrusion force F2 applied to the hot end assembly corresponding to the first compensation coefficient. In one embodiment, that the extrusion force f applied to the hot end assembly tends to be stable at the fourth moment t₆₄ can be understood as that the value of the extrusion force sampled at the fourth moment t₆₄ and the value of the extrusion force sampled at the previous sampling moment relative to the fourth moment t₆₄ are within a preset range. For example, the value of the extrusion force sampled at the fourth moment t₆₄ is equal to the value of the extrusion force sampled at the previous sampling moment relative to the fourth moment t₆₄. In FIG. 6, the first theoretical extrusion force being greater than the first actual extrusion force and the second actual extrusion force being greater than the second theoretical extrusion force are used as an example. Optionally, the first theoretical extrusion force may be less than the first actual extrusion force, or the second actual extrusion force may be less than the second theoretical extrusion force.

In one embodiment, the second theoretical extrusion force may be determined based on the first theoretical extrusion force, for example, the first theoretical extrusion force is proportional to the second theoretical extrusion force.

In the present application, the extrusion wheel continuously decreases the extrusion printing material during the deceleration period, and the extrusion force applied to the hot end assembly continuously decreases and then tends to be stable. The value at which the extrusion force tends to be stable is the theoretical extrusion force of the extrusion wheel. In this case, the value obtained through sampling is used as the theoretical value, which avoids tedious theoretical calculation, saves calculation resources for the system, and provides high efficiency.

In step 303, a target compensation coefficient of the extrusion wheel is obtained based on the one or more extrusion forces applied to the hot end assembly corresponding to the first compensation coefficient. In one embodiment, the target compensation coefficient of the extrusion wheel is obtained based on the data indicative of the extrusion force or the deformation applied to the hot end assembly, the data corresponding to the first compensation coefficient.

In one embodiment, the step further includes: an extrusion wheel is controlled, to extrude the printing material to the hot end assembly based on the target compensation coefficient of the extrusion wheel.

In one embodiment, the 3D printer includes a controller configured to control an extrusion wheel to compensate or superimpose an extrusion feed amount, thereby compensating for a lag of extrusion pressure of the extrusion wheel and improving printing quality.

By controlling the extrusion wheel to compensate or superimpose the extrusion feed amount, the lag of the extrusion pressure of the extrusion wheel can be compensated, thereby improving the printing quality of the 3D printer. As a result, the details of the printed object become clearer and the extrusion becomes more stable. In 3D printing scenarios involving frequent changes in printing speed or high-speed printing, the printing effect can be significantly improved.

When the printing material in a molten state flows out from the hot end assembly, the relationship between the flow rate of the hot end assembly and the pressure in the melt chamber of the hot end assembly can be expressed as:

$${Q}_{R} = \frac{π {R}^{4} Δ P}{8 HL} \qquad Formula 1$$

where Q_{R} represents the flow rate of the hot end assembly, R represents the orifice radius of the hot end assembly (i.e., the radius of the nozzle in the hot end assembly), ΔP represents the pressure in the melt chamber of the hot end assembly, H represents a constant coefficient, and L represents the orifice length of the hot end assembly (i.e., the height of the conical portion of the nozzle in the hot end assembly).

According to Formula 1, it can be seen that the pressure in the melt chamber of the hot end assembly is directly proportional to the flow rate of the hot end assembly.

Since the cross-sectional area of the printing material in a solid state is constant, the pressure in the melt chamber of the hot end assembly is directly proportional to the extrusion force applied to the hot end assembly.

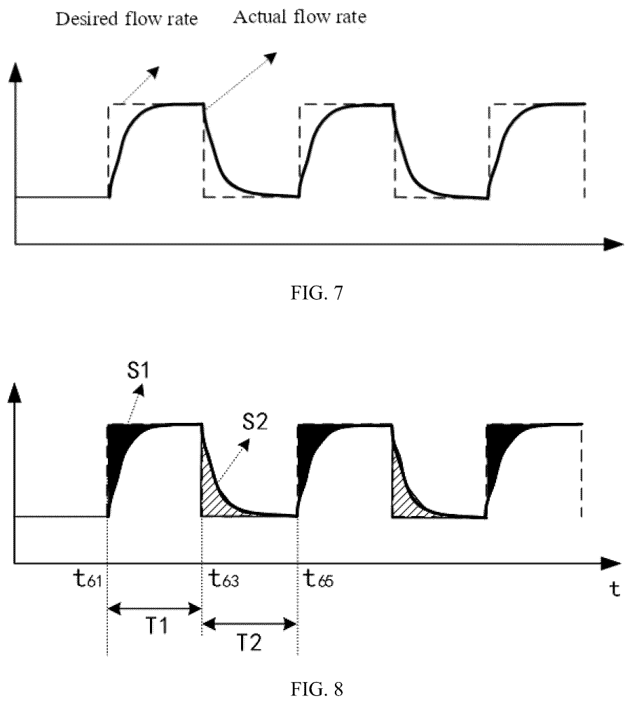

Thus, the flow rate of the hot end assembly is directly proportional to the extrusion force applied to the hot end assembly. In this case, the flow rate curve of the hot end assembly may be as shown in FIG. 7; that is, the flow rate curve of the hot end assembly exhibits the same trend as the curve of the extrusion force applied to the hot end assembly.

In some feasible embodiments, the difference between the theoretical extrusion force and the actual extrusion force that correspond to each compensation coefficient is integrated with respect to time over the extrusion speed variation cycle of the extrusion wheel to obtain the flow rate difference corresponding to each compensation coefficient.

With reference to FIGS. 6 and 8, it can be seen that during the first period T1, the first theoretical extrusion force corresponding to the first compensation coefficient is greater than the first actual extrusion force applied to the hot end assembly; that is, during the first period, the extrusion of the hot end assembly is insufficient. In this case, the difference obtained by subtracting the first actual extrusion force applied to the hot end assembly from the first theoretical extrusion force corresponding to the first compensation coefficient is integrated with respect to time over the first period to obtain the first flow rate area difference S1 corresponding to the first compensation coefficient, which may be expressed by the formula:

$$S 1 = {\int }_{{t}_{61}}^{{t}_{63}} ( F 1 - f ) dt \qquad Formula 2$$

During the second period T2, the second theoretical extrusion force corresponding to the first compensation coefficient is less than the second actual extrusion force applied to the hot end assembly; that is, during the second period, the extrusion of the hot end assembly is excessively large. In this case, the difference obtained by subtracting the second theoretical extrusion force corresponding to the first compensation coefficient from the second actual extrusion force applied to the hot end assembly is integrated with respect to time over the second period to obtain the second flow rate area difference S2 corresponding to the first compensation coefficient, which may be expressed by the formula:

$$S 2 = {\int }_{{t}_{63}}^{{t}_{65}} ( f - F 2 ) dt \qquad Formula 3$$

In this case, the flow rate difference corresponding to the first compensation coefficient is the sum of the first flow rate area difference and the second flow rate area difference.

The foregoing, with reference to FIGS. 6 to 8, describes a manner of calculating the flow rate difference of the first compensation coefficient among the one or more compensation coefficients. The flow rate differences corresponding to the one or more compensation coefficients can be obtained according to the foregoing manner of calculating the flow rate difference of the first compensation coefficient by changing the value of the compensation coefficient.

In one embodiment, in some feasible embodiments, after the flow rate area difference is obtained, the flow rate difference corresponding to each compensation coefficient can be obtained by further calculating the volumetric flow rate.

The target compensation coefficient of the extrusion wheel is obtained based on the flow rate difference of the hot end assembly corresponding to each compensation coefficient.

In some feasible embodiments, through steps 301 to 303, the flow rate difference corresponding to the first compensation coefficient and the flow rate difference of the second compensation coefficient can be obtained, and the target compensation coefficient of the extrusion wheel is obtained based on the sign relationship between the flow rate difference of the hot end assembly corresponding to the first compensation coefficient and the flow rate difference of the hot end assembly corresponding to the second compensation coefficient. In the present application, the target compensation coefficient is selected based on the sign relationship between two values, which is simple and effective, and the target compensation coefficient of the extrusion wheel can be accurately obtained.

In one embodiment, in some feasible embodiments, since the flow rate of the hot end assembly is directly proportional to the extrusion force applied to the hot end assembly, the target extrusion compensation coefficient of the extrusion wheel can be directly calculated according to the extrusion force based on the proportional relationship between the flow rate of the hot end assembly and the extrusion force applied to the hot end assembly.

In some feasible embodiments, the target compensation coefficient of the extrusion wheel can be obtained based on the theoretical extrusion force and the actual extrusion force that are of the hot end assembly and correspond to the first compensation coefficient.

In one embodiment, the target compensation coefficient of the extrusion wheel may be obtained by processing the first compensation coefficient based on the proportional relationship between the theoretical extrusion force and the actual extrusion force. That is, there may be a linear multiplicative relationship between the target compensation coefficient and the first compensation coefficient. For example, the target compensation coefficient k may be expressed by the formula:

$$k = \frac{{F}_{T 1}}{{F}_{A 1}} \times {k}_{1} \qquad Formula 4$$

where k₁ represents the first compensation coefficient, F_{T1} represents the theoretical extrusion force corresponding to the first compensation coefficient, and F_{A1} represents the actual extrusion force applied to the hot end assembly corresponding to the first compensation coefficient. If the hot end assembly is subjected to one or more extrusion forces corresponding to the first compensation coefficient, F_{A1} may be an average value or a median of the one or more extrusion forces.

Assume that when the first compensation coefficient k₁=0.8, the theoretical extrusion force of the hot end assembly is 10 N—the theoretical extrusion force may be a preset target value—but the extrusion force actually applied to the hot end assembly and measured by the measurement assembly is 5 N. In this case, according to Formula 4, the target compensation coefficient is 1.6.

In one embodiment, the target compensation coefficient of the extrusion wheel may be obtained by processing the first compensation coefficient based on the proportional relationship between the theoretical extrusion force and the actual extrusion force and the positive correlation relationship between the extrusion force and the flow rate. That is, the target compensation coefficient is positively correlated with the first compensation coefficient. For example, the target compensation coefficient k may be expressed by the formula:

$$k = \frac{{F}_{T 2}}{{F}_{A 2}} \times {k}_{1} \times μ \qquad Formula 5$$

where k₁ represents the first compensation coefficient, F_{T2}F_{T2} represents the theoretical extrusion force corresponding to the first compensation coefficient, and F_{A2}F_{A2} represents the actual extrusion force applied to the hot end assembly corresponding to the first compensation coefficient. If the hot end assembly is subjected to one or more extrusion forces corresponding to the first compensation coefficient, F_{A2} may be an average value or a median of the one or more extrusion forces. μ represents a positive correlation coefficient between the extrusion force and the flow rate, which may be retrieved from a preset mapping table between extrusion force and positive correlation coefficient based on the extrusion force F_{A2}.

Assume that when the first compensation coefficient k₁k₁=0.8, the theoretical extrusion force of the hot end assembly is 10 N—the theoretical extrusion force may be a preset target value—but the extrusion force actually applied to the hot end assembly and measured by the measurement assembly is 5 N, and μ=0.9. In this case, according to Formula 5, the target compensation coefficient is 1.44.

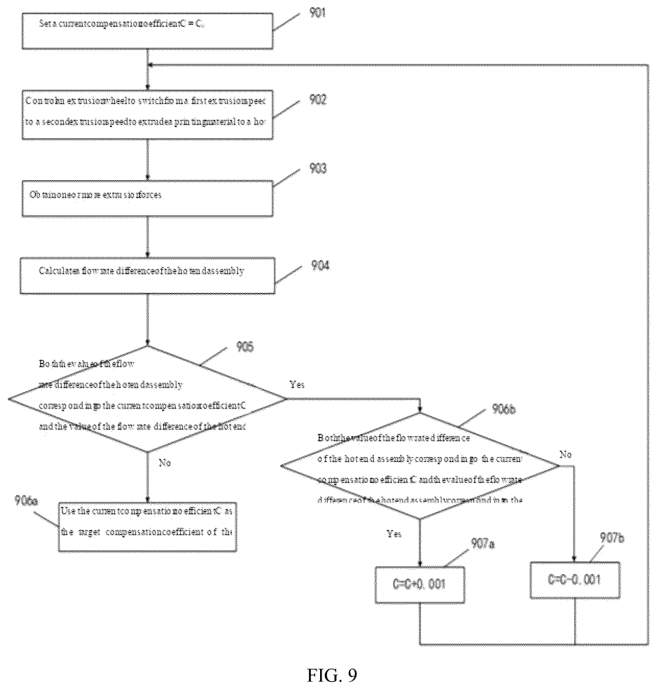

In some feasible embodiments, the determination of the target compensation coefficient from the one or more compensation coefficients is described below with reference to the schematic flowchart of an extrusion compensation method for an extrusion wheel shown in FIG. 9. The specific steps are as follows:

In step 901, a current compensation coefficient C=C₀ is set.

C₀ can be understood as the initial compensation coefficient, which is a preset value. In one embodiment, the value of C₀ may be 0 or may be an empirically determined value to reduce the number of iterations.

In step 902, the extrusion wheel is controlled to switch from a first extrusion speed to a second extrusion speed to extrude the printing material to the hot end assembly. For this step, reference may be made to step 301 in the embodiments described above with reference to FIG. 3, which is not repeated herein.

In step 903, one or more extrusion forces are obtained. For this step, reference may be made to step 302 in the embodiments described above with reference to FIGS. 3 to 5, which is not repeated herein.

In step 904, the flow rate difference of the hot end assembly is calculated. For this step, reference may be made to step 302 in the embodiments described above with reference to FIGS. 3 and 6, which is not repeated herein.

In step 905, it is determined whether both the value of the flow rate difference of the hot end assembly corresponding to the current compensation coefficient C and the value of the flow rate difference of the hot end assembly corresponding to the previous compensation coefficient are positive values or negative values. If yes, step 906b is performed; otherwise, step 906a is performed.

In one embodiment, when step 901 is performed for the first time, the process is started based on the initial compensation coefficient, and in the case that the previous compensation coefficient of the initial compensation coefficient does not exist or the previous compensation coefficient of the initial compensation coefficient is the initial compensation coefficient itself, step 906b is performed. Then, step 907a or 907b is performed.

In step 906a, the current compensation coefficient C is used as the target compensation coefficient of the extrusion wheel.

If the value of the flow rate difference of the hot end assembly corresponding to the current compensation coefficient C is a positive value, and the value of the flow rate difference of the hot end assembly corresponding to the previous compensation coefficient of the current compensation coefficient is a negative value, it indicates that the current compensation coefficient C (i.e., the second compensation coefficient) is relatively small, and the previous compensation coefficient (i.e., the first compensation coefficient) of the current compensation coefficient is relatively large. In this case, the second compensation coefficient is close to the desired value and can be used as the target compensation coefficient of the extrusion wheel to improve the printing effect of the 3D printer. In one embodiment, the first compensation coefficient may also be used as the target compensation coefficient of the extrusion wheel.

In one embodiment, if the value of the flow rate difference of the hot end assembly corresponding to the current compensation coefficient C is a negative value, and the value of the flow rate difference of the hot end assembly corresponding to the previous compensation coefficient of the current compensation coefficient is a positive value, it indicates that the current compensation coefficient C (i.e., the second compensation coefficient) is relatively large, and the previous compensation coefficient (i.e., the first compensation coefficient) of the current compensation coefficient is relatively small. In this case, the second compensation coefficient is close to the desired value and can be used as the target compensation coefficient of the extrusion wheel to improve the printing effect of the 3D printer. In one embodiment, the first compensation coefficient may also be used as the target compensation coefficient of the extrusion wheel.

In step 906b, it is determined whether both the value of the flow rate difference of the hot end assembly corresponding to the current compensation coefficient C and the value of the flow rate difference of the hot end assembly corresponding to the previous compensation coefficient are positive values. If yes, step 907a is performed; otherwise, step 907b is performed.

In step 907a, C=C+0.001. If both the value of the flow rate difference of the hot end assembly corresponding to the current compensation coefficient C and the value of the flow rate difference of the hot end assembly corresponding to the previous compensation coefficient are positive values, it indicates that the current compensation coefficient C (i.e., the second compensation coefficient) and the previous compensation coefficient (i.e., the first compensation coefficient) of the current compensation coefficient are relatively small. In this case, the second compensation coefficient is increased by a first preset step size. Then, steps 901 to 905 are repeated until the sign of the value of the flow rate difference of the hot end assembly corresponding to the second compensation coefficient is different from the sign of the value of the flow rate difference of the hot end assembly corresponding to the first compensation coefficient, and the second compensation coefficient is used as the target compensation coefficient of the extrusion wheel.

In FIG. 9, the first preset step size of 0.001 is used as an example. The first preset step size may also be set to another value. The value of the first preset step size is not limited in the present application.

In step 907b, C=C−0.001. If both the value of the flow rate difference of the hot end assembly corresponding to the current compensation coefficient C and the value of the flow rate difference of the hot end assembly corresponding to the previous compensation coefficient are negative values, it indicates that the current compensation coefficient C (i.e., the second compensation coefficient) and the previous compensation coefficient (i.e., the first compensation coefficient) of the current compensation coefficient are relatively large. In this case, the second compensation coefficient is decreased by a second preset step size. Then, steps 901 to 905 are repeated until the sign of the value of the flow rate difference of the hot end assembly corresponding to the second compensation coefficient is different from the sign of the value of the flow rate difference of the hot end assembly corresponding to the first compensation coefficient, and the second compensation coefficient is used as the target compensation coefficient of the extrusion wheel.

In FIG. 9, the second preset step size of 0.001 is used as an example. The second preset step size may be equal to the first preset step size or may also be set to another value. The value of the second preset step size is not limited in the present application.

In the present application, the flow rate difference of the hot end assembly is changed by dynamically changing the compensation coefficient, and dynamic flow rate compensation can be performed on the hot end assembly during the 3D printing process. The operation is simple and the efficiency is high.

In some feasible embodiments, the present application further provides a 3D printer. The 3D printer is provided with a printing head and a controller. The printing head includes a printing head body, and the printing head body is provided with an extrusion wheel and a hot end assembly. The controller can implement the embodiments described above with reference to FIGS. 3 to 9, thereby achieving dynamic flow rate compensation for the 3D printer and improving the printing effect of the 3D printer.

An embodiment of the present application further provides a computer-readable storage medium storing a computer program thereon. The computer program, when run by a processor, causes the processor to implement the embodiments described above with reference to FIGS. 3 to 9.

An embodiment of the present application further provides a computer program product including a computer program. The computer program, when run by a processor, causes the processor to implement the embodiments described above with reference to FIGS. 3 to 9.

It should be noted that the above terms “first” and “second” are only for the purpose of description, and may not be construed as indicating or implying the relative importance.

What is claimed is:

1. An extrusion compensation method for an extrusion wheel, comprising:
controlling an extrusion wheel of a 3D printer, in a case of compensation by a first compensation coefficient, to switch from a first extrusion speed to a second extrusion speed to extrude a printing material to a hot end assembly of the 3D printer;
obtaining, from a measurement assembly of the 3D printer, data indicative of an extrusion force or a deformation applied to the hot end assembly, the data corresponding to the first compensation coefficient;
obtaining a target compensation coefficient of the extrusion wheel based on the data indicative of the extrusion force or the deformation applied to the hot end assembly, the data corresponding to the first compensation coefficient; and
controlling the extrusion wheel to extrude the printing material to the hot end assembly based on the target compensation coefficient of the extrusion wheel.

2. The extrusion compensation method according to claim 1, further comprising:
controlling the extrusion wheel, in a case of compensation by a second compensation coefficient, to switch from a third extrusion speed to a fourth extrusion speed to extrude the printing material to the hot end assembly; and
obtaining, from the measurement assembly, data indicative of an extrusion force or a deformation applied to the hot end assembly, the data corresponding to the second compensation coefficient;
wherein obtaining the target compensation coefficient of the extrusion wheel based on the data indicative of the extrusion force or the deformation applied to the hot end assembly, comprises:
obtaining the target compensation coefficient of the extrusion wheel based on:
(i) data indicative of the extrusion force or the deformation applied to the hot end assembly corresponding to the first compensation coefficient; and
(ii) data indicative of the extrusion force or the deformation applied to the hot end assembly corresponding to the second compensation coefficient.

3. The extrusion compensation method according to claim 2, wherein obtaining the target compensation coefficient of the extrusion wheel based on:
(i) data indicative of the extrusion force or the deformation applied to the hot end assembly corresponding to the first compensation coefficient; and
(ii) data indicative of the extrusion force or the deformation applied to the hot end assembly corresponding to the second compensation coefficient,
the obtaining comprising:
integrating a difference between the theoretical extrusion force and the actual extrusion force, or a difference between the theoretical deformation and the actual deformation of the hot end assembly, corresponding to a same compensation coefficient, with respect to time over an extrusion speed variation cycle of the extrusion wheel to obtain:
(i) a flow rate difference of the hot end assembly corresponding to the first compensation coefficient; and
(ii) a flow rate difference of the hot end assembly corresponding to the second compensation coefficient; and
obtaining the target compensation coefficient of the extrusion wheel based on a sign relationship between:
(i) the flow rate difference of the hot end assembly corresponding to the first compensation coefficient; and
(ii) the flow rate difference of the hot end assembly corresponding to the second compensation coefficient.

4. The extrusion compensation method according to claim 3, wherein obtaining the target compensation coefficient of the extrusion wheel based on the sign relationship between the flow rate difference of the hot end assembly corresponding to the first compensation coefficient and the flow rate difference of the hot end assembly corresponding to the second compensation coefficient comprises:
when the flow rate difference of the hot end assembly corresponding to the first compensation coefficient is a positive value, and the flow rate difference of the hot end assembly corresponding to the second compensation coefficient is a negative value, using the second compensation coefficient or the first compensation coefficient as the target compensation coefficient of the extrusion wheel.

5. The extrusion compensation method according to claim 3, wherein obtaining the target compensation coefficient of the extrusion wheel based on the sign relationship between the flow rate difference of the hot end assembly corresponding to the first compensation coefficient and the flow rate difference of the hot end assembly corresponding to the second compensation coefficient comprises:
when the flow rate difference of the hot end assembly corresponding to the first compensation coefficient is a negative value, and the flow rate difference of the hot end assembly corresponding to the second compensation coefficient is a positive value, using the second compensation coefficient or the first compensation coefficient as the target compensation coefficient of the extrusion wheel.

6. The extrusion compensation method according to claim 3, wherein obtaining the target compensation coefficient of the extrusion wheel based on the sign relationship between the flow rate difference of the hot end assembly corresponding to the first compensation coefficient and the flow rate difference of the hot end assembly corresponding to the second compensation coefficient comprises:
when both the flow rate difference of the hot end assembly corresponding to the first compensation coefficient and the flow rate difference of the hot end assembly corresponding to the second compensation coefficient are positive values, increasing the second compensation coefficient until a flow rate difference of the hot end assembly corresponding to the increased second compensation coefficient is a negative value, and using the increased second compensation coefficient as the target compensation coefficient of the extrusion wheel.

7. The extrusion compensation method according to claim 3, wherein obtaining the target compensation coefficient of the extrusion wheel based on the sign relationship between the flow rate difference of the hot end assembly corresponding to the first compensation coefficient and the flow rate difference of the hot end assembly corresponding to the second compensation coefficient comprises:
when both the flow rate difference of the hot end assembly corresponding to the first compensation coefficient and the flow rate difference of the hot end assembly corresponding to the second compensation coefficient are negative values, decreasing the second compensation coefficient until a flow rate difference of the hot end assembly corresponding to the decreased second compensation coefficient is a positive value, and using the decreased second compensation coefficient as the target compensation coefficient of the extrusion wheel.

8. The extrusion compensation method according to claim 3, wherein:
(i) a theoretical extrusion force or theoretical deformation corresponding to each compensation coefficient comprises a first theoretical extrusion force or theoretical deformation and a second theoretical extrusion force or theoretical deformation; and
(ii) an actual extrusion force or actual deformation corresponding to each compensation coefficient comprises a first actual extrusion force or actual deformation and a second actual extrusion force or actual deformation;
and the method further comprises:
controlling, in the case that the extrusion wheel is subjected to the compensation by the first compensation coefficient, an extrusion speed variation of the extrusion wheel to comprise acceleration and deceleration, and an extrusion speed variation cycle of the extrusion wheel to comprise an accelerated first period and a decelerated second period;
integrating a difference obtained by subtracting the first actual extrusion force or actual deformation from the first theoretical extrusion force or theoretical deformation corresponding to each compensation coefficient with respect to time over the first period to obtain a first flow rate area difference corresponding to each compensation coefficient;
integrating a difference obtained by subtracting the second theoretical extrusion force or theoretical deformation from the second actual extrusion force or actual deformation corresponding to each compensation coefficient with respect to time over the second period to obtain a second flow rate area difference corresponding to each compensation coefficient; and
obtaining a flow rate difference corresponding to each compensation coefficient based on the first flow rate area difference and the second flow rate area difference that correspond to each compensation coefficient.

9. The extrusion compensation method according to claim 8, wherein during the first period, the extrusion force or the deformation corresponding to the first compensation coefficient increases from a first moment and tends to be stable at a second moment;
the first actual extrusion force or actual deformation corresponding to the first compensation coefficient is an extrusion force or a deformation corresponding to the first compensation coefficient between the first moment and the second moment;
the first theoretical extrusion force or theoretical deformation corresponding to the first compensation coefficient is an extrusion force or a deformation after the second moment during the first period.

10. The extrusion compensation method according to claim 8, wherein during the second period, the extrusion force or the deformation corresponding to the first compensation coefficient decreases from a third moment and tends to be stable at a fourth moment;
the second actual extrusion force or actual deformation corresponding to the first compensation coefficient is an extrusion force or a deformation corresponding to the first compensation coefficient between the third moment and the fourth moment;
the second theoretical extrusion force or theoretical deformation corresponding to the first compensation coefficient is an extrusion force or a deformation after the fourth moment during the second period.

11. The extrusion compensation method according to claim 1, wherein the measurement assembly comprises a strain gauge and/or a distance sensing device.

12. The extrusion compensation method according to claim 1, wherein the 3D printer is provided with a support between the extrusion wheel and the hot end assembly, and the measurement assembly comprises the distance sensing device arranged on a side of the support facing the hot end assembly;
the distance sensing device is configured to sense and/or measure a distance between the hot end assembly and the support.

13. The extrusion compensation method according to claim 1, wherein the hot end assembly is connected to a strain cantilever, and the measurement assembly comprises a strain gauge attached to a surface of the strain cantilever;
the strain gauge is configured to measure deformation of the surface of the strain cantilever.

14. A 3D printer, comprising:
a printing head, comprising a printing head body, wherein the printing head body is provided with an extrusion wheel and a hot end assembly;
a measurement assembly, configured to measure an extrusion force or a deformation applied to the hot end assembly; and
a controller comprising:
at least one processor; and
at least one memory comprising a computer program code, wherein the at least one memory, the computer program code, and the at least one processor are collectively configured, to cause the 3D printer to at least perform:
controlling the extrusion wheel, in a case of compensation by a first compensation coefficient, to switch from a first extrusion speed to a second extrusion speed to extrude a printing material to the hot end assembly;
obtaining, from the measurement assembly of the 3D printer, data indicative of an extrusion force or a deformation applied to the hot end assembly, the data corresponding to the first compensation coefficient;
obtaining a target compensation coefficient of the extrusion wheel based on the data indicative of the extrusion force or the deformation applied to the hot end assembly, the data corresponding to the first compensation coefficient; and
controlling the extrusion wheel to extrude the printing material to the hot end assembly based on the target compensation coefficient of the extrusion wheel.

15. An electronic device, comprising:
at least one processor; and
at least one memory comprising a computer program code, wherein the at least one memory, the computer program code, and the at least one processor are collectively configured, to cause the electronic device to at least perform:
controlling an extrusion wheel of a 3D printer, in a case of compensation by a first compensation coefficient, to switch from a first extrusion speed to a second extrusion speed to extrude a printing material to a hot end assembly of the 3D printer;
obtaining, from a measurement assembly of the 3D printer, data indicative of an extrusion force or a deformation applied to the hot end assembly, the data corresponding to the first compensation coefficient;
obtaining a target compensation coefficient of the extrusion wheel based on the data indicative of the extrusion force or the deformation applied to the hot end assembly, the data corresponding to the first compensation coefficient; and
controlling the extrusion wheel to extrude the printing material to the hot end assembly based on the target compensation coefficient of the extrusion wheel.
